(19) United States
(12) Patent Application Publication
(10) Pub. No.: US 2015/0208715 A1
(43) Pub. Date: Jul. 30, 2015

(54) METHOD FOR INSULATING THE FILLING CONTENTS OF A FOOD PRODUCT

(71) Applicant: N.N.T., Lessines (BE)

(72) Inventors: Tippawan Willems, Hombeek (BE); Nid Wongjampa, Hombeek (BE); Valerie Jacqueline Seron, Jehay (BE)

(73) Assignee: N.N.T., Lessines (BE)

(21) Appl. No.: 14/419,922

(22) PCT Filed: Jul. 30, 2013
(86) PCT No.: PCT/EP2013/065978

§ 371 Date: Feb. 5, 2015

(30) Foreign Application Priority Data
Aug. 7, 2012 (BE) 2012/0529

(51) Int. Cl. A23P 1/08; A23P 1/10

(52) U.S. Cl. CPC A23P 1/087; A23P 1/105

(57) ABSTRACT

The invention relates to a method for insulating the filling contents of a food product, including the following steps: providing at least one shell initially made of an edible moldable material; applying at least one coating layer including B at least one fatty substance in said shell in order to form an inner insulating coating layer; feeding the filling contents into said shell; applying at least one covering layer including at least one fatty substance onto the filling contents in order to obtain a continuous insulating covering layer that bonds to said inner insulating coating layer; and closing said shell by applying an edible moldable material, characterized in that the second and fourth steps are preceded by cooling to a temperature of around −25° C. to 30° C., and in that the fifth step is preceded by a step of heating said upper surface of said mold.

The present invention relates to a method for isolating the filling content of a food product comprising the following sequential steps:
a first step consisting of providing, in a mold having an upper face, at last one shell formed from an edible molding material, this shell having at least one internal wall and a filling aperture;
a second step consisting of applying at least one coating layer comprising at least one fat onto said at least one internal wall of said shell in moldable material in order to form an insulating internal coating layer;
a third step consisting of inserting said filling content of said food product into said shell in moldable material through said filling aperture;
a fourth step consisting of applying at least one covering layer comprising at least one fat onto said filling content in order to obtain a continuous insulating covering layer binding to said insulating internal coating layer;
a fifth step consisting of closing said filling aperture of said shell by applying an edible moldable material onto said continuous insulating covering layer.

Said method is known from document EP 1378174 for example concerning the filling of a food product with a substance. The isolating of the filling content is performed to allow longer preservation of the filled food products obtained. More specifically this document discloses a method allowing the isolation of a moist filling of a food product. At a first step, there is applied to the inner walls of a previously molded shell in edible product one or more insulating layers comprising a fat or mixture of fats. At a second step, the filling content is inserted in the said molded shell the walls of which were previously coated with at least one fat. At a third step, one or more insulating layers are applied comprising a fat or mixture of fats on the upper visible portion of the said filling content. Finally, the said shell is closed by applying food product to the layer comprising at least one fat and covering the said filling content to form a cover for the said shell. This method is more particularly applied when the filling products have a creamy or pasty consistency e.g. filling products such as creamy, viscous or pasty yoghurts.

Said method is also known from document U.S. Pat. No. 2,682,471. According to this document, the content is isolated from the container (chocolate shell) by a layer of fat (cocoa butter). More particularly, this document concerns the isolating within a chocolate shell of a viscous or syrupy substance (or “cordialized” substance). The purpose is therefore to isolate a substance which unavoidably contains sugar without which a viscous syrup or “cordialized” substance cannot be obtained. Additionally, so that the filling content does not flow outside the container it is essential that it should contain a high proportion of sugar which, via drying and/or crystallization, seals the micro-fissures that are inevitably present with the isolating method used in document U.S. Pat. No. 2,682,471. According to this method, a first layer of fat is applied inside a chocolate shell and a filling content is then inserted in this shell before being covered with a second layer of fat which welds to the first. This closing via welding inevitably allows micro-fissures to subsist at the junction zone between the two layers of fat. Without crystallization and/or drying of the sugar in the filling content at the micro-fissures this filling content may leak through to the surface of the chocolate shell which itself is permeable.

Unfortunately as can be ascertained these methods known in the prior art do not allow the isolating of a liquid content such as alcohol for example e.g. alcohol without added sugar or syrup. First it cannot be envisaged to apply one or more layers comprising at least one fat if the said filling content is entirely liquid: the fat layers would not form a continuous protective film adequately adhering to the filling content but would float on top of the said liquid filling content. By applying the methods known in the state of the art, adequate isolating of the filling content of a food product can only be obtained if the said insulating layer or layers are continuous and form a film or coating entirely around the said filling content.

In addition, according to these methods known in the prior art, the inevitable presence of micro-fissures at the junction zone between the two fat layers (first fat layer applied inside the chocolate shell and second fat layer applied to the content placed in this same shell) is a recurrent problem when isolating a filling content. As mentioned above, solely the presence of sugar or syrup added to the filling content or the presence of a highly viscous filling content can allow the sealing of these micro-fissures via drying and/or crystallization within these very micro-fissures, particularly at the junction zone between the two above-mentioned fat layers. It is therefore only possible according to current methods to isolate syrupy and viscous contents and certainly not liquid contents that are non-sweetened and/or have viscosity similar to water.

It is the objective of the invention to overcome the disadvantages of the prior art by providing a method with which it is possible to isolate any type of filling content i.e. filling contents that are either creamy, pasty or soft or are entirely liquid (i.e. having the viscosity of water or which contain water) whether or not sweetened and whether or not containing alcohol.

To solve this problem there is provided according to the invention a method for isolating the filling content of a food product such as first indicated above, characterized in that the said second and fourth steps are preceded by cooling down to a temperature in the order of −25° C. to 30° C., and in that the said fifth step is preceded by a heating step of said upper face of the said mold.

Said method of the invention during which the said second and fourth steps are preceded by a cooling step, and during which the said fifth step is preceded by a heating step of said upper side of the said mold particularly at the junction zone between the said insulating inner coating layer and the said covering layer of the filling content, allows the isolating of a fully liquid filling content of a food product and thereby the obtaining of food products comprising a filling content in entirely liquid form.

In the present invention it is first shown that such cooling operations ensure optimal adhering of the said insulating inner coating layer comprising at least one fat on the inner walls of the said shell molded from edible moldable material. Second, it is shown in the invention that the heating step of the upper face of the mold, in particular of the junction zone between the said insulating inner coating layer and the said covering layer of the filling content, before closing the filling aperture of the shell, allows the eliminating of any presence and/or formation of micro-fissures at the junction zone between the said insulating inner coating layer and the said covering layer of the filling content, which ensures perfect isolating of the filling content. In addition, this heating of the upper face of the mold prevents the applied edible moldable material from solidifying too rapidly and from forming a fixed, hardened layer over the entire surface of the said mold.

The application of one or more insulating layers comprising at least one fat onto the walls having a surface temperature in the order of −25° C. to 30° C., preferably in the order of −10° C. to 20° C., more preferably in the order of −5° C. to 10° C. promotes the solidification of the fats in the form of a continuous, homogeneous insulating layer that attaches to the walls. This is why, when a fully liquid filling substance is inserted in the said shell the walls of which have been cooled before applying at least one insulating inner coating layer comprising at least one fat, the said insulating inner coating layer remains stable and adheres to the walls of the said shell molded from edible moldable material.

Also, said temperatures allow extensive cooling of the said liquid filling content which can therefore, depending on its type, either undergo a phase change or exhibit a temperature in the order of −25° C. to 30° C., preferably in the order of −10° C. to 20° C., more preferably in the order of −5° C. to 10° C. Said temperature of said filling content therefore permits the applying of one or more continuous insulating covering layers comprising at least one fat onto a surface having a temperature in the order of −25° C. to 30° C., preferably in the order of −10° C. to 20° C., more preferably in the order of −5° C. to 10° C., and thereby allows optimal solidification and adherence of the said continuous insulating cover layer comprising at least one fat. Also, as mentioned above, said temperature promotes the solidification of the fats which will therefore form a continuous, homogeneous insulating layer surrounding the said filling content.

In the present invention it is shown that the defined temperature ranges are particularly adapted since a temperature that is too high (higher than 30° C.) would not allow proper adherence to be obtained either of the said insulating inner coating layer or of the said continuous insulating cover layer both comprising at least one fat, whilst a temperature that is too low (lower than −25° C.) would cause too rapid solidification of these same layers which would lead to the forming of fat clusters and hence to a non-homogeneous insulating layer.

The temperature difference, between the layers comprising at least one fat and the layers on which these layers are applied comprising at least one fat, determines the rapidity of solidification of the fats. The greater this temperature difference the quicker the fats will solidify on the surface having a temperature lower than that of the applied fats. Also, the temperature of the applied fats must always be lower than the melt temperature of the surfaces (shell or filling content) onto which they are applied to avoid the melting of the said surfaces.

The heating step of the upper face of the mold before closing the filling aperture of the shell is performed at a temperature at least equal to the melt temperature of the fats respectively forming a first fat layer (cooled insulating inner coating layer applied to the inner wall of the shell) and a second fat layer (covering layer on the filling content). This second fat layer is applied at a temperature higher than its melt temperature and higher than that of the cooled insulating inner coating layer without, however, exceeding the melt temperature of the shell to prevent deterioration thereof. This heating, performed for example using an (industrial) blowtorch, allows the melting of these two fat layers so that they fuse together and melt homogenously without any formation of micro-fissures. In addition, since the filling content has previously been cooled, once the fusing between these fat layers (inner coating layer and covering layer) has taken place under the effect of the said heating, the lower temperature of the filling content allows rapid setting of the fusing of these two fat layers which also contributes towards preventing any presence and/or formation of micro-fissures.

In addition, according to the invention, an additional heating step of the shell can be carried out to ensure proper closing thereof, this being known in the prior art.

By the term <<optimal adherence>> in the present invention is meant adherence such that it does not allow the said insulating layer to become detached from the walls on which it is applied when a liquid substance comes into contact with the said insulating layer. By the term <<continuous, homogeneous layer>> in the present invention is meant a layer forming a film or coating completely covering the substrate on which it is applied. Said continuous, homogeneous layer in particular prevents any evaporation or drying of the filling content but also any contamination of the filling content by the edible moldable material forming the walls of the shell inside which the filling content is inserted.

When, according to the present invention, several successive layers comprising at least one fat are applied one on top of the other, intermediate cooling steps down to a temperature in the order of −25° C. to 30° C. are performed between the application of two successive layers. Advantageously, as described above, the application of a layer comprising at least one fat on a preceding layer cooled to such temperatures allows optimal adherence to be obtained of a continuous and homogeneous layer.

Advantageously according to the method of the present invention, the said cooling is conducted down to a temperature in the order of −10° C. to 20° C.

Advantageously according to the method of the present invention, the said cooling is conducted down to a temperature in the order of −5° C. to 10° C.

Preferably at the said third step, the said filling content is inserted in the shell when the temperature of the filing is moderate or slightly cooled, the said temperature being defined as a function of the said at least one fat used to form the said insulating inner coating layer. According to the present invention, the temperature of the said filling content should not promote detaching of the said insulating inner coating layer under the effect of a temperature that is too high deteriorating the adhering of the said insulating inner coating layer to the walls of the shell.

Advantageously according to the method of the present invention, the said shell is formed from an edible moldable material selected from the group formed by chocolate or any other edible substance having similar rheological properties to those of chocolate, or the mixtures thereof.

According to the present invention, several shells can be placed side by side and thereby form a product such as a chocolate bar for example formed of a series of shells, each shell possibly containing or not containing a filling content.

Preferably according to the method of the present invention, the said at least one insulating inner coating layer comprising at least one fat is formed from a fat selected from the group formed by coconut oil, palm oil, cocoa butter, shea butter or any fat having similar properties in terms of solidification, and the mixtures thereof.

Preferably, according to the method of the present invention, the said at least one continuous insulating covering layer comprising at least one fat is formed from a fat selected from the group formed by coconut oil, palm oil, cocoa butter, shea butter or any fat having similar properties, and the mixtures thereof.

Said fats are edible and widely used in the food sector. They are therefore particularly indicated for use such as described in the present invention. Also, these fats according to the method of the invention allow the isolating of a fully liquid filling content from the walls of a shell molded from an edible material (e.g. chocolate) by forming a continuous, homogeneous layer having optimal adherence. Advantageously such properties of the said layer allow the preventing of any contamination and/or deterioration of the said filling content which therefore maintains its taste, aromas and all its rheological or other properties.

Advantageously, according to the method of the present invention, the said at least one insulating inner coating layer comprising at least one fat is applied at the melt temperature or higher of the said at least one fat.

Advantageously according to the method of the present invention, the said at least one continuous, insulating cover layer comprising at least one fat is applied at the melt temperature or higher of the said at least one fat.

When the said at least one fat is of said temperature it can easily be applied by spraying or spreading so as to form a continuous and homogeneous film on the treated surface, for example on the walls of a shell molded in edible material.

Preferably, according to the method of the present invention, the said filling content of the said food product is selected from the group formed by creamy, pasty, soft, liquid filling contents that are sweetened or non-sweetened, whether or not containing alcohol.

Preferably, according to the method of the present invention, the said filling content of the said food product is an alcohol whether or not mixed with at least one other filling substance that is creamy, pasty, soft or liquid, sweetened or non-sweetened.

By alcohol in the present invention is meant a food alcohol such as vodka, brandy, whisky, port, liqueurs or Pastis for example. These alcohols may be mixed for example with orange juice, energizing drinks, fruit coulis, crystallized fruit or any other sweet or non-sweet filling substance.

Preferably according to the method of the present invention, the said filling content of the said food product is a syrup or coulis whether or not containing alcohol.

With the method of the invention, by means of the cooling steps applied according to the present invention, it is possible to isolate any type of filling content, whether pasty, viscous, creamy or entirely liquid, sweet or non-sweet, whether or not containing alcohol.

Advantageously according to the method of the present invention, fruit flesh or pulp are be contained in the said filling contents that are either creamy, pasty, soft or liquid, sweet or non-sweet, whether or not containing alcohol.

Advantageously the method of the invention further comprises a step to form at least one bearing point of the said food product, the said at least one bearing point being arranged to form a supporting projection underneath the said food product. Said bearing point allows the ensured passing of air underneath the food product and promotes air movement around the entire food product making it possible to reduce or considerably delay melting of the shell formed from an edible moldable material e.g. a shell in chocolate. This bearing point also allows the preventing of any direct contact of the food product with a supporting surface, imparting the food product with better resistance to ambient temperatures and preventing deterioration of the shell e.g. via melting of the shell.

In addition, since the passing and circulating of air are aided through the presence of at least one such bearing point, the inner temperature of the shell and of the food product is reduced, allowing the fat layers (coating and covering layers) to better withstand and to withstand longer any increase in ambient temperature. As a result, the fat layers are accordingly better preserved and can thereby better ensure isolation of the filling content such as obtained with the method of the present invention. In the present invention it was determined that the presence of at least one such bearing point enables the food products to withstand a temperature up to at least 4° C. higher than the melt temperature generally observed.

In addition, a said bearing point allows the reducing and even elimination of problems related to condensation generally observed on and at the lower portion of the food products, thereby optimizing the preserving thereof.

The step to form the bearing points can be performed in the mold at the same time as the shell is formed. In this case the mold must be designed for this purpose. This step may also be performed after release of the food product from the mold by affixing the said at least one bearing point. For example when the product is still in the mold and the moldable closing material is still hot or tepid (malleable) it is possible to insert a hard to sufficiently hard edible material such as a fragment of hazelnut or almond. It is also possible to apply an edible substance which will harden in the form of droplets, lines or any other form allowing a sufficient space to be formed between the said food product and the support on which it rests to facilitate the passing of air (or ventilation).

According to the invention, provision is also made for the forming of a said bearing point when the product is cold, inside or outside the mold. It is possible for example, using known methods, to apply droplets, lines or any other desired shape of a substance which will form a sufficient space between the said food product and the support on which it rests to facilitate ventilation.

Other embodiments of the method of the invention are indicated in the appended claims.

Other characteristics, details and advantages of the invention will become apparent from the description given below that is non-limiting and refers to the appended Figures.

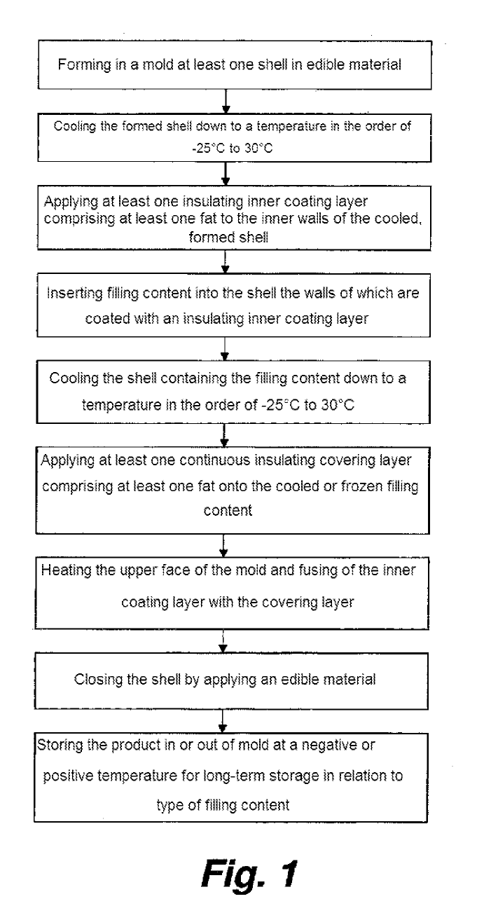

FIG. 1 illustrates the succession of steps of the invention to isolate the filling content of a food product.

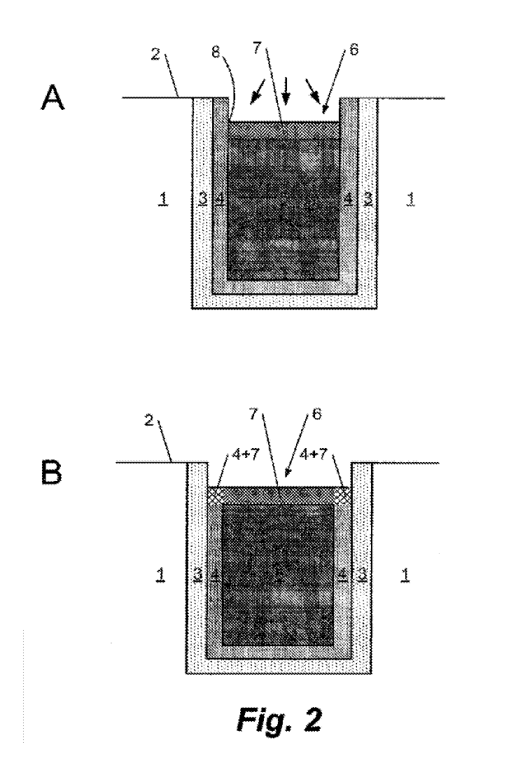

FIGS. 2A and 2B illustrate isolating of a filling content according to the invention.

As schematized, at a first step a shell in edible material is formed in a mold. At a second step, the said shell formed at the preceding step is cooled down to a temperature in the order of −25° C. to 30° C., preferably in the order of −10° C. to 20° C., more preferably in the order of −5° C. to 10° C. so that, at a third step during which at least one insulating inner coating layer comprising at least one fat is applied, this insulating inner coating layer forms a continuous and homogenous layer optimally adhering to the walls of the said shell. At a fourth step, the said filling content is inserted in the said shell the walls of which are coated with at least one insulating inner coating layer comprising at least one fat. At a fifth step, the said shell containing the said filling content is cooled down to a temperature in the order of −25° C. to 30° C., preferably in the order of −10° C. to 20° C., more preferably in the order of −5° C. to 10° C. so that, at a sixth step to apply the at least one continuous insulating cover layer comprising at least one fat onto the said filling content, this continuous insulating cover layer forms a continuous, homogeneous layer optimally adhering to the filling content. An additional step entails heating the upper face of the mold so that the said cooled inner coating layer fuses with the said covering layer without forming micro-fissures to isolate the filling content entirely from the container and hence from the outside medium. A last step then involves closing the said shell by applying an edible material to the said continuous, homogeneous insulating cover layer previously applied to the said filling content. The filled food products obtained are then either released from the mold or left in the said mold and stored in a dry place at a temperature preferably between 1° C. and 18° C. depending on the filling content under consideration. For example, a temperature in the order of 1° C. to 10° C. is preferred when the said filling content contains fruit. A temperature in the order of 1° C. to 15° C. is preferred when the said filling content comprises an alcohol. A temperature in the order of 1° C. to 18° C. is preferred when the said filling content comprises coffee.

Evidently the products obtained can also be stored by freezing whether or not they are kept in a mold. Therefore the filled products, which may or may not be released from the mold, are stored at a suitable negative or positive temperature in relation to the desired storage time and taking into account the type of content to ensure long-term preservation.

FIG. 2A illustrates a mold 1 having an upper face 2 in which a shell 3 has been formed (e.g. a shell in chocolate) the inner walls of which after cooling were coated with at least one layer of fat 4 forming an insulating inner coating layer. A filling content 5 was then inserted via a filling aperture 6 into the shell 3 and the assembly was cooled before applying at least one covering layer 7 comprising at least one fat onto the said filling content 5.

As illustrated, the said at least one covering layer 7 comprising at least one fat binds along a weld line 8 to the said at least one layer of cooled and hence cold fat layer 4 forming an insulating inner coating layer. Said binding along a weld line 8 inevitably involves the presence of micro-fissures enabling the filling content 5 to leak through to the shell 3.

However, as illustrated in FIG. 2B, subsequent to heating (illustrated by the arrows) of the upper face 2 of the mold 1, these two fat layers having initially different temperatures at the weld line 8 fuse together 4+7 at this weld line 8 so that the presence of a weld line 8 is fully eliminated. Consequently any presence and/or formation of micro-fissures is eliminated. In addition, since the content 5 and the illustrated elements 1 to 4 were previously cooled and therefore their temperature is lower than the temperature of the zone where the fat layers 4+7 fused by melting, this fat zone 4+7 is rapidly set which also contributes to avoiding any presence and/or formation of micro-fissures. Said fusing of the fat layers mentioned above guarantees perfect imperviousness and hence perfect isolating of the filling content 5 whether or not this content is fully liquid, viscous, syrupy, “cordialized” or sweetened.

Evidently the present invention is in no way limited to the embodiment described above and numerous modifications can be made thereto without departing from the scope of the appended claims.

1. A method for isolating the filling content of a food product comprising the following sequential steps:
a first step consisting of providing, in a mold having an upper face, at least at one shell formed of initially with an edible moldable material, this shell having at least one internal wall and a filling aperture,
a second step consisting of applying at least one coating layer comprising at least one fat on said at least one internal wall of said shell in a moldable material in order to form an insulating internal coating layer,
a third step consisting of introducing said filling content of said food product into said shell in moldable material through said filling aperture,
a fourth step consisting of applying at least one covering step comprising at least one fat on said filling content in order to obtain a continuous insulating covering layer binding to said insulating internal coating layer,
a fifth step consisting of closing said filling aperture of said shell by applying an edible moldable material onto said continuous insulating covering layer, characterized in that said second and fourth steps are preceded with cooling down to a temperature of the order of −25° C. to 30° C. and in that said fifth step is preceded with a step for warming up said upper face of said mold.

2. A method for isolating the filling content of a food product according to claim 1, characterized in that said cooling is carried out down to a temperature of the order of −10° C. to 20° C.

3. The method for isolating the filling content of a food product according to claim 1, characterized in that said cooling is carried out down to a temperature of the order of −5° C. to 10° C.

4. The method for isolating the filling content of a food product according to claim 1, characterized in that said shell is initially formed from an edible moldable material selected from the group consisting of chocolates and any other edible substance having rheological properties similar to those of chocolate, and mixtures thereof.

5. The method for isolating the filling content of a food product according to claim 1, characterized in that said at least one insulating internal coating layer comprising at least one fat is initially formed from fats selected from the group consisting of coconut oil, palm oil, cocoa butter, shea butter, and of any fats having similar properties in terms of solidification, and mixtures thereof.

6. The method for isolating the filling content of a food product according to claim 1, characterized in that said at least one continuous insulating covering layer comprising at least one fat is initially formed from fats selected from the group consisting of coconut oil, palm oil, cocoa butter, shea butter and of any fats having similar properties, and mixtures thereof.

7. The method for isolating the filling content of a food product according to claim 5, characterized in that said at least one insulating internal coating layer comprising at least one fat is applied at a temperature greater than or equal to the melting temperature of said at least one fat.

8. The method for isolating the filling content of a food product according claim 5, characterized in that said at least one continuous insulating covering layer comprising at least one fat, is applied at a temperature greater than or equal to the melting temperature of said at least one fat.

9. The method for isolating the filling content of a food product according to claim 1, characterized in that said filling content of said food product is selected from the group consisting of creamy, pasty, soft and liquid filling contents, either sweetened or non-sweetened, either alcoholic or not.

10. The method for isolating the filling content of a food product according to claim 1, characterized in that said filling content of said food product is alcohol either mixed or not with at least one other creamy, pasty, soft or liquid substance, either sweetened or non-sweetened.

11. The method for isolating the filling content of a food product according to claim 1, characterized in that said filling content of said food product is a syrup or coulis, either alcoholic or not.

12. The method for isolating the filling content of a food product according to claim 1, characterized in that some fruit flesh or pulp are added into said creamy, pasty, soft or liquid filling contents, either sweetened or non-sweetened, either alcoholic or not.

13. The method for isolating the filling content of a food product according to any claim 1, characterized in that it further comprises a step for forming at least one supporting point of said food product, said at least one supporting point being laid out so as to form a leg under said food product.
